(19) United States
(12) Patent Application Publication
(10) Pub. No.: US 2026/0266715 A1
(43) Pub. Date: Sep. 10, 2026

(54) SPECTROPHOTOMETER AND SPECTROMETRIC DATA PROCESSING METHOD

(71) Applicant: SHIMADZU CORPORATION, Kyoto-shi (JP)

(72) Inventor: Yuki ISHIKAWA, Kyoto-shi (JP)

(21) Appl. No.: 19/559,111

(22) Filed: Mar. 6, 2026

(30) Foreign Application Priority Data
Mar. 7, 2025 (JP) 2025-036286

(51) Int. Cl. G01N 21/3504; G01J 3/42; G01N 21/35

(52) U.S. Cl. CPC G01N 21/3504; G01J 3/42; G01N 2021/3595

(57) ABSTRACT

A spectrophotometer (10) comprises: a measurement spectrum acquisition unit (151) configured to acquire a measurement spectrum obtained by spectrophotometric measurement; a measurement spectrum peak identifying unit (152) configured to identify a measurement peak which is a peak existing in the measurement spectrum; a removal target wavenumber equivalent value acquisition unit (153) configured to acquire, from a database, a removal target wavenumber equivalent value which is a wavenumber equivalent value of a peak attributed to a molecule of a known component whose concentration in a measurement atmosphere fluctuates; and a removal target peak removing unit (154) configured to perform processing of removing, from the measurement spectrum, a measurement peak located at a position corresponding to the removal target wavenumber equivalent value.

### TECHNICAL FIELD

The present invention relates to a spectrophotometer, such as a Fourier transform infrared spectrophotometer (FTIR), and a spectrometric data processing method.

### BACKGROUND ART

In measurement using a spectrophotometer, generally, background correction is performed on a sample spectrum measured with a sample in a measurement optical path using a background spectrum measured without a sample in the measurement optical path. In FTIR, by dividing a sample spectrum (power spectrum) by a background spectrum (also a power spectrum), an absorbance spectrum, which is the absorbance for each wavenumber of the sample, or a transmittance spectrum, which is the reciprocal thereof, is obtained. However, if the measurement atmosphere changes between the time of measuring the sample and the time of measuring the background, the amounts of water vapor, carbon dioxide, and the like in the atmosphere existing on the measurement optical path change between the two measurements. As a result, the intensities of peaks derived from the measurement atmosphere, such as water (water vapor) and carbon dioxide, differ between the sample spectrum and the background spectrum. In this case, the background derived from the measurement atmosphere cannot be correctly corrected, and there is a possibility that the absorbance spectrum or the transmittance spectrum cannot be correctly obtained.

Therefore, in the spectrophotometer described in Patent Document 1, after identifying unnecessary component peaks derived from the measurement atmosphere from the background spectrum, a temporary transmittance spectrum is obtained from a reference spectrum obtained by subtracting the unnecessary component peaks from the background spectrum, and a temporary corrected sample spectrum obtained by subtracting the unnecessary component peaks multiplied by a temporary coefficient from the sample spectrum. By correcting the coefficient based on the validity of the obtained temporary transmittance spectrum, a final transmittance spectrum is obtained.

### CITATION LIST

### Patent Literature

Patent Document 1 JP 2008-275326 A

### SUMMARY OF INVENTION

### Technical Problem

In the drawings of Patent Document 1, one relatively wide unnecessary component peak is depicted. However, actually, as in the background power spectrum illustrated in FIG. 1, several to several tens of unnecessary component peaks narrower than that appear concentrated within a wavenumber width of about 200 to 700 cm⁻¹.

The problem to be solved by the present invention is to provide a spectrophotometer and a spectrometric data processing method capable of obtaining a correct absorbance spectrum or transmittance spectrum even if there are unnecessary component peaks whose intensities fluctuate between the time of measuring a background spectrum and the time of measuring a sample spectrum.

### Solution to Problem

A spectrophotometer according to the present invention made to solve the above problem comprises: a measurement spectrum acquisition unit configured to acquire a measurement spectrum indicating a relationship between a wavenumber equivalent value and intensity, obtained by spectrophotometric measurement; a measurement spectrum peak identifying unit configured to identify a measurement peak which is a peak existing in the measurement spectrum; a removal target wavenumber equivalent value acquisition unit configured to acquire, from a database, a removal target wavenumber equivalent value which is a wavenumber equivalent value of a peak attributed to a molecule of a known component whose concentration in a measurement atmosphere fluctuates; and a removal target peak removing unit configured to perform processing of removing, from the measurement spectrum, a measurement peak located at a position corresponding to the removal target wavenumber equivalent value.

A spectrometric data processing method according to the present invention includes: a measurement spectrum acquisition step of acquiring a measurement spectrum indicating a relationship between a wavenumber equivalent value and intensity, obtained by spectrophotometric measurement; a measurement spectrum peak identifying step of identifying a measurement peak which is a peak existing in the measurement spectrum; a removal target wavenumber equivalent value acquisition step of acquiring, from a database, a removal target wavenumber equivalent value which is a wavenumber equivalent value of a peak attributed to a molecule of a known component whose concentration in a measurement atmosphere fluctuates; and a removal target peak removing step of performing processing of removing, from the measurement spectrum, a measurement peak located at a position corresponding to the removal target wavenumber equivalent value.

The measurement spectrum may be either a background spectrum or a sample spectrum. When the measurement spectrum is a background spectrum, the measurement peak to be removed (hereinafter, "removal target peak") is removed from the background spectrum, and the removal target peak can also be removed from the sample spectrum using a value obtained by multiplying the intensity of the removal target peak in the background spectrum by a predetermined coefficient. On the other hand, when the measurement spectrum is a sample spectrum, the removal target peak is directly removed from the sample spectrum. Further, the measurement spectrum is not particularly limited as long as it is obtained by spectrophotometric measurement.

The wavenumber equivalent value includes values such as wavelength and frequency obtained from the wavenumber, in addition to the value of the wavenumber itself.

The database used in the removal target wavenumber equivalent value acquisition unit may be included in the spectrophotometer according to the present invention, or may be provided outside the spectrophotometer according to the present invention. In the latter case, the removal target wavenumber equivalent value acquisition unit acquires the removal target wavenumber equivalent value from the database via a communication line such as the Internet. As such an external database, for example, "HITRAN" provided online can be used.

The phrase "located at a position corresponding to the removal target wavenumber equivalent value" regarding the measurement peak includes not only the case where the position of the measurement peak and the removal target wavenumber equivalent value substantially match, but also the case where there is some error (for example, within ±1%) between the two.

### Advantageous Effects of Invention

According to the present invention, a removal target wavenumber equivalent value, which is a wavenumber equivalent value in a removal target peak attributed to a molecule of a known component whose concentration in a measurement atmosphere fluctuates, such as water (water vapor) or carbon dioxide in the atmosphere on a measurement optical path or the like, is acquired from a database, and then a measurement peak located at a position (having a wavenumber equivalent value) corresponding to the removal target wavenumber equivalent value is removed from the measurement spectrum. Therefore, it is possible to prevent a measurement peak whose concentration in the measurement atmosphere does not fluctuate from being erroneously removed as an unnecessary component peak whose concentration fluctuates, thereby making it possible to obtain a correct absorbance spectrum or transmittance spectrum.

### BRIEF DESCRIPTION OF DRAWINGS

FIG. 1 is a diagram showing an example of a background power spectrum obtained by an infrared spectrophotometer.

FIG. 2 is a schematic configuration diagram showing an embodiment of a spectrophotometer according to the present invention.

FIG. 3 is a flowchart showing an embodiment of a spectrometric data processing method according to the present invention.

FIG. 4 is a graph showing an example of a measurement spectrum.

FIG. 5 is a graph showing a state in which removal target peaks in the measurement spectrum shown in FIG. 4 are identified according to the present embodiment.

FIG. 6 is a graph showing a result of removing the removal target peaks from the measurement spectrum shown in FIG. 4 according to the present embodiment.

FIG. 7 is a graph showing an example of highlighting and displaying identified removal target peaks in the present embodiment.

FIG. 8 is a schematic configuration diagram showing a modification of the spectrophotometer according to the present invention.

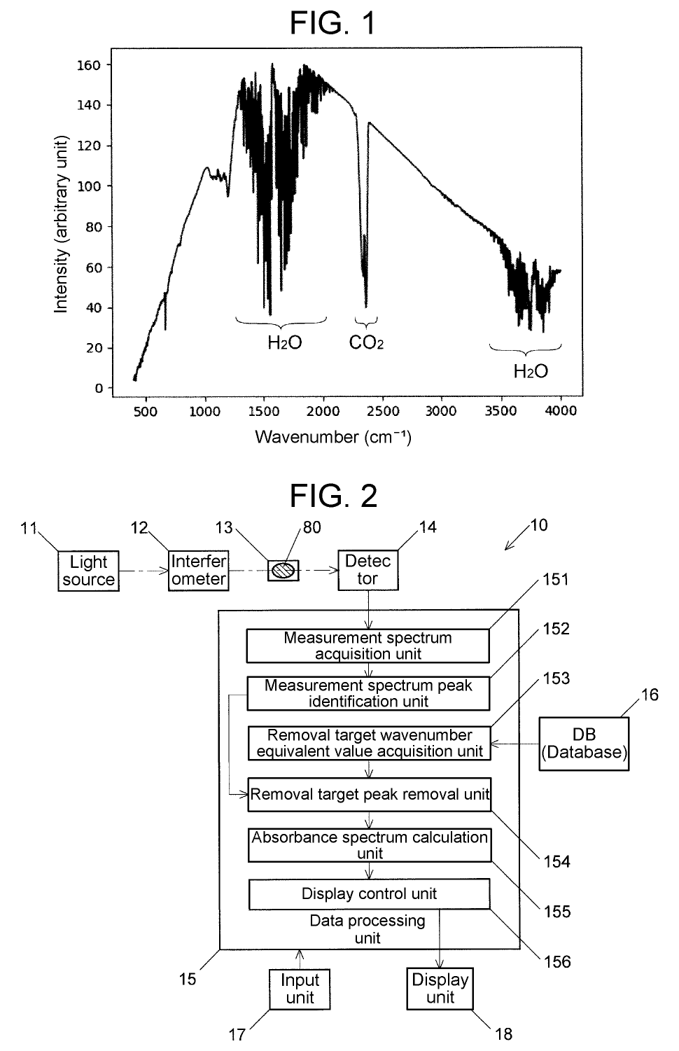

### DESCRIPTION OF EMBODIMENTS

Embodiments of a spectrophotometer and a spectrometric data processing method according to the present invention will be described using FIGS. 2 to 8.

A spectrophotometer 10 of the present embodiment is an FTIR, and as shown in FIG. 2, includes a light source 11, an interferometer 12, a sample holder 13, a detector 14, a data processing unit 15, a database (DB) 16, an input unit 17, and a display unit 18.

The light source 11 emits infrared light. The interferometer 12 is disposed on the optical path of the infrared light from the light source 11 and converts the infrared light into an interferogram, which is interference light whose amplitude periodically fluctuates with the passage of time. For the interferometer 12, for example, a Michelson interferometer can be used. The sample holder 13 is disposed on the optical path of the interference light converted by the interferometer 12 and holds a sample 80 to be measured. The detector 14 detects transmitted light resulting from the interference light passing through the sample 80 as measurement light. Instead of transmitted light, reflected light reflected by the sample 80 may be detected as measurement light.

The data processing unit 15 has, as functional blocks, a measurement spectrum acquisition unit 151, a measurement spectrum peak identifying unit 152, a removal target wavenumber equivalent value acquisition unit 153, a removal target peak removing unit 154, an absorbance spectrum calculation unit 155, and a display control unit 156. Details of each unit included in the data processing unit 15 as functional blocks will be described later together with the description of the spectrometric data processing method of the present embodiment. The data processing unit 15 is implemented with hardware such as a CPU and memory of a personal computer (PC), and software installed in the PC.

The DB 16 stores a correspondence relationship between a wavenumber equivalent value (wavenumber, wavelength, or frequency) of a peak of a measurement spectrum (details will be described later) obtained by FTIR and a component (molecule) contained in a sample or background from which the peak is derived. When carrying out the spectrometric data processing method of the present embodiment, among the data stored in the DB 16, wavenumber equivalent values of peaks derived mainly from water and carbon dioxide in the atmosphere contained in the measurement atmosphere are used. However, besides this, in order to perform analysis based on a measurement spectrum obtained from a sample, the DB 16 stores wavenumber equivalent values of peaks for numerous components that various samples can contain. In the present embodiment, the spectrophotometer 10 itself possesses the DB 16, but instead, the spectrophotometer 10 itself may not possess the DB, and may connect to an external DB through a communication line such as the Internet.

The input unit 17 is for an operator to input information necessary for measurement operation by the spectrophotometer 10, data processing of the present embodiment, and the like, and corresponds to a keyboard, a mouse, a touch panel, and the like. Based on control by the display control unit 156, the display unit 18 is a display that displays various information obtained during measurement, information to be presented to the operator during data processing of the present embodiment, results obtained by data processing of the present embodiment, and the like.

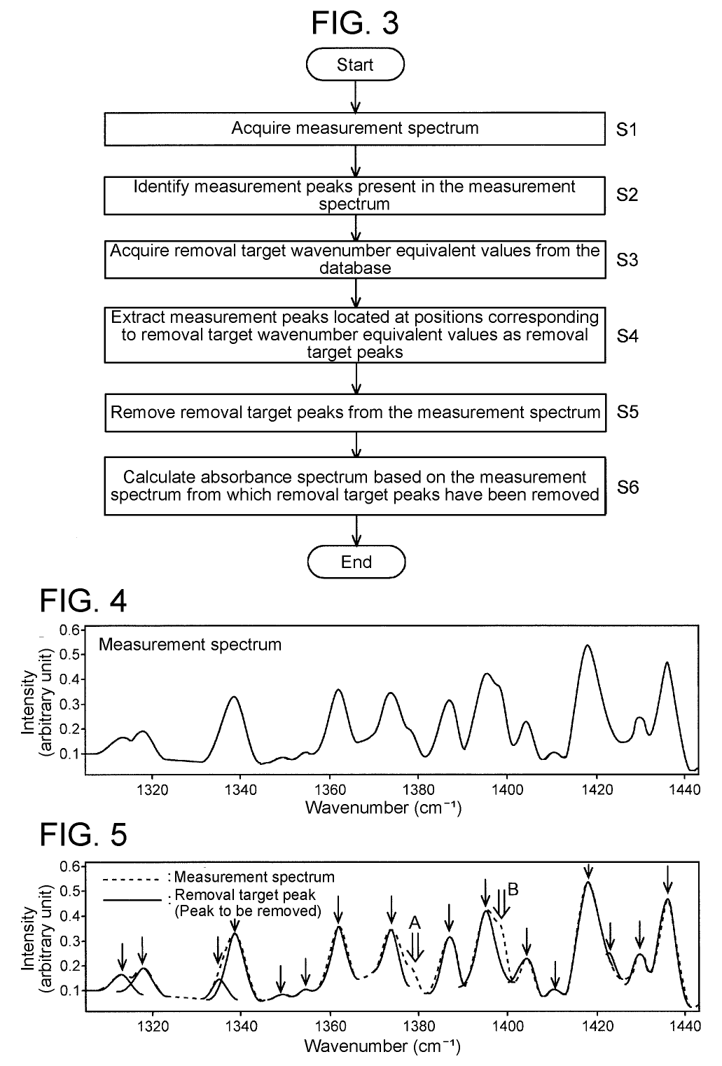

Hereinafter, the operation of the spectrophotometer 10 and the spectrometric data processing method of the present embodiment will be described with reference to the flowchart of FIG. 3.

When the operator performs a predetermined operation using the input unit 17, the measurement spectrum acquisition unit 151 performs processing of acquiring a measurement spectrum (Step 1: Measurement spectrum acquisition step). Specifically, a sample spectrum is acquired based on an intensity value of a detection signal of the detector 14 obtained in a state where the sample 80 is held in the sample holder 13, and a background spectrum is acquired based on an intensity value similarly obtained in a state where the sample 80 is not held in the sample holder 13. The measurement spectrum is a general term for the sample spectrum and the background spectrum. Note that either the sample spectrum or the background spectrum may be acquired first. Here, the sample spectrum is obtained as an intensity value for each wavenumber by converting infrared light emitted from the light source 11 into interference light whose amplitude periodically fluctuates with a change in optical path difference in the interferometer 12, transmitting or reflecting the light at the sample 80, detecting the light with the detector 14, and performing a Fourier transform operation on the intensity value of the detection signal obtained for each magnitude of optical path difference. The background spectrum is obtained by a method similar to that for the sample spectrum, except that the interference light is detected by the detector 14 (without being transmitted or reflected at the sample 80).

Among the following operations, Steps 2 to 5 may be performed only on the background spectrum of the measurement spectra, or may be performed on both the background spectrum and the sample spectrum.

After execution of Step 1, the measurement spectrum peak identifying unit 152 identifies a peak (measurement peak) existing in the measurement spectrum obtained in Step 1 (Step 2: Measurement spectrum peak identifying step). As a method for identifying the measurement peak, a general method performed on data (chromatogram or mass spectrum) obtained by FTIR or other analysis apparatuses may be used.

Next, the removal target wavenumber equivalent value acquisition unit 153 acquires, from the DB 16, a removal target wavenumber equivalent value which is a wavenumber equivalent value of a peak attributed to a molecule of a known component whose concentration in the measurement atmosphere fluctuates (Step 3: Removal target wavenumber equivalent value acquisition step). In the present embodiment, molecules of components contained in the atmosphere in the measurement atmosphere whose concentration fluctuates for each measurement are targeted, and among them, wavenumber equivalent values of peaks of water and carbon dioxide, which appear as particularly high peaks in the measurement spectrum, are acquired as removal target wavenumber equivalent values. Note that Step 3 only needs to be executed before Step 4 described next, and may be executed immediately before either Step 1 or 2. Alternatively, it may be executed in parallel with either Step 1 or 2.

Next, the removal target peak removing unit 154 extracts, from among the measurement peaks identified in Step 2, those located at a position (wavenumber equivalent value) corresponding to the removal target wavenumber equivalent value acquired in Step 3 as removal target peaks (Step 4). Here, "corresponding to the removal target wavenumber equivalent value" includes not only the case where the position (wavenumber equivalent value) of the measurement peak and the removal target wavenumber equivalent value completely match, but also the case where there is an error within ±1% between the two.

Subsequently, the removal target peak removing unit 154 performs processing of removing the removal target peak extracted in Step 4 from the measurement spectrum (Step 5). The processing combining Step 4 and Step 5 corresponds to the removal target peak removing step described above. The removal processing of the measurement peak from the measurement spectrum performed in Step 5 can be performed, for example, by obtaining the positions of both ends of the peak from the shape of the measurement peak and approximating between the both ends with a straight line.

When the processing of Steps 2 to 5 is performed on both the sample spectrum and the background spectrum, the process immediately proceeds to Step 6 as shown in FIG. 3. On the other hand, when the processing of Steps 2 to 5 is performed only on the background spectrum, processing of removing the removal target peak from the sample spectrum is performed using data regarding the removal target peak in the background spectrum between Step 5 and Step 6 (not shown). This processing can be performed, for example, by obtaining the removal target peak extracted in Step 4 from among the measurement peaks in the background spectrum, and subtracting a value obtained by multiplying its intensity value by a predetermined coefficient from the sample spectrum. The predetermined coefficient here can be obtained by, for example, the method described in Patent Document 1.

In Step 6, the absorbance spectrum calculation unit 155 calculates an absorbance spectrum based on the sample spectrum and the background spectrum after the removal target peaks have been removed (Absorbance spectrum calculation step). For the calculation of the absorbance spectrum, a method similar to that performed in conventional FTIR can be used. The calculated absorbance spectrum is displayed on the display unit 18 based on control by the display control unit 156. The series of processing ends here.

FIGS. 4 to 6 show an example in which removal target peaks are identified from a measurement spectrum and then the removal target peaks are removed. Note that in a normal power spectrum, peaks are convex downward because the intensity of light decreases due to absorption of light by molecules, but in FIGS. 4 to 6, peaks are shown as convex upward.

The diagram shown in FIG. 4 is an example of a background spectrum which is a measurement spectrum. Each of the multiple measurement peaks seen in this measurement spectrum was identified, and its wavenumber equivalent value (wavenumber itself in the examples of FIGS. 4 to 6) was obtained. Then, after obtaining the peak wavenumbers of the measurement peaks, they were compared with the peak wavenumbers of water and carbon dioxide stored in the DB. As a result, the peaks shown by solid lines in FIG. 5 and pointed to by single-line arrows (different from double-line arrows described later) matched the peak wavenumbers of water, and were found to be removal target peaks derived from the atmosphere in the measurement atmosphere. On the other hand, the two peaks pointed to by double-line arrows and denoted by reference signs A and B in FIG. 5 did not match the peak wavenumbers of water and carbon dioxide. These two peaks are presumed to be peaks originally existing in the background spectrum, not derived from the atmosphere.

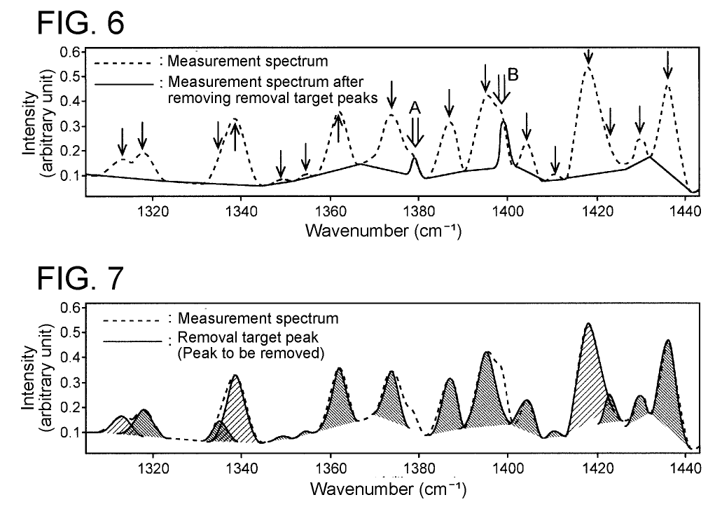

After identifying the removal target peaks and the peaks originally existing in the background spectrum in this way, processing of subtracting only the removal target peaks from the background spectrum was performed. In this processing, the positions of both ends of the removal target peak were respectively obtained, and the removal target peak was subtracted by connecting between the both ends with a straight line, while the originally existing peaks denoted by reference signs A and B were left in the background spectrum. The background spectrum after removing the removal target peaks is shown by a solid line in FIG. 6.

According to the spectrophotometer and the spectrometric data processing method of the present embodiment, removal target peaks in the measurement spectrum caused by water (water vapor), carbon dioxide, or the like in the atmosphere whose concentration fluctuates in the measurement atmosphere on the measurement optical path between the light source 11 and the detector 14 or the like are identified based on the removal target wavenumber equivalent values stored in the DB 16, and then removed from the measurement spectrum. Therefore, it is possible to prevent a measurement peak whose concentration in the measurement atmosphere does not fluctuate from being erroneously removed as an unnecessary component peak whose concentration fluctuates. Thereby, a correct absorbance spectrum or transmittance spectrum can be obtained.

The present invention is not limited to the above embodiment, and various modifications are possible.

For example, in the above embodiment, after extracting the removal target peak in Step 4, processing of removing the removal target peak from the measurement spectrum is immediately performed in Step 5. Instead, after Step 4, based on control by the display control unit 156, the measurement spectrum (before removing the removal target peak) may be displayed on the display unit 18, and the removal target peak may be highlighted. Thereby, the operator can understand the removal target peaks contained in the measurement spectrum at a glance. As a method of highlighting the removal target peak, for example, besides indicating the peak with an arrow as shown in FIG. 5, a symbol other than an arrow (circle mark, triangle mark) may be displayed at the position of the peak. Alternatively, as shown in FIG. 7, the peak may be hatched or colored. In that case, it is preferable to display a plurality of peaks whose peak wavenumber equivalent values are close to each other and which appear to overlap with mutually different hatching or colors (two different types of hatching are used in the example of FIG. 7). Thereby, the plurality of peaks can be easily distinguished. Alternatively, all peaks may be displayed with mutually different hatching or colors. By looking at the removal target peaks displayed on the display unit 18 as described above, the operator can confirm whether or not the removal target peaks are appropriately selected.

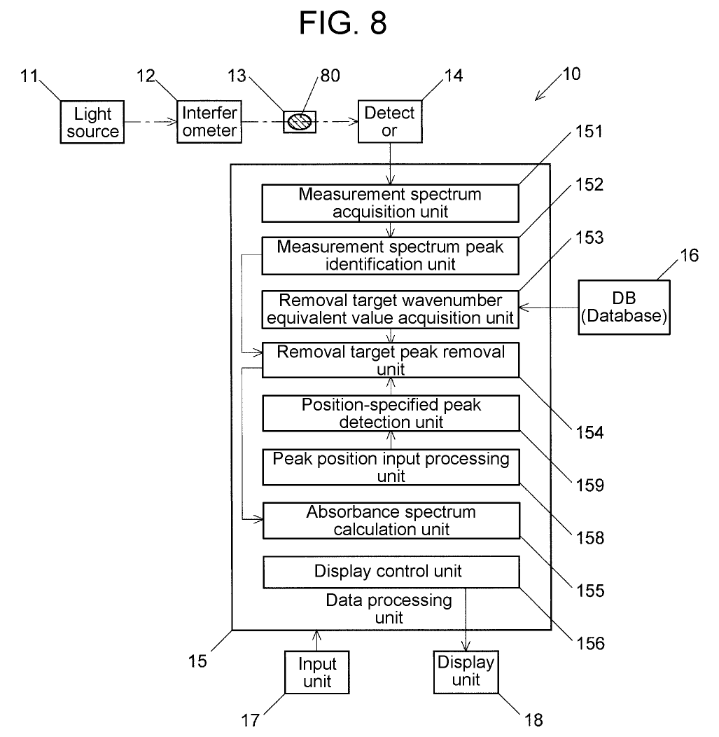

In the above embodiment, among the peaks contained in the measurement spectrum, measurement peaks that do not correspond to the removal target wavenumber equivalent values acquired from the DB 16 (peaks denoted by reference signs A and B in the example of FIG. 5) are not removed from the measurement spectrum. Since such peaks are usually essentially peaks not derived from the measurement atmosphere, it is appropriate not to remove them. However, for example, in a case where it is a peak for which the removal target wavenumber equivalent value is not stored, or in a case where, although it is a peak for which the removal target wavenumber equivalent value is stored, the position of the measurement peak wavenumber differs from the removal target wavenumber equivalent value exceeding the allowable error due to a measurement problem or the like, it may not be selected as a removal target peak even though it is originally a peak that should be removed. Therefore, as shown in FIG. 8, the data processing unit 15 may further have a peak position input processing unit 157 and a position specified peak detection unit 158 as functional blocks.

According to the configuration having the peak position input processing unit 157 and the position specified peak detection unit 158, after displaying the measurement spectrum on the display unit 18 by control of the display control unit 156, the peak position input processing unit 157 identifies a position specified by the operator using the input unit 17 by a mouse click operation or the like on the measurement spectrum. Next, the position specified peak detection unit 158 detects a peak existing at the position input by the peak position input processing unit 157 (called a "position specified peak" to distinguish it from a removal target peak automatically selected based on the removal target wavenumber equivalent value). Then, the removal target peak removing unit 154 performs processing of removing the position specified peak from the measurement spectrum in addition to the removal target peak. Thereby, a position specified peak, which was not selected as a removal target peak even though it should originally be removed from the measurement spectrum, can be removed from the measurement spectrum.

In the configuration shown in FIG. 8, the data processing unit 15 may further have an error correction unit (not shown) that corrects the allowable error between the position of the measurement peak and the removal target wavenumber equivalent value based on the difference between one of the removal target wavenumber equivalent values stored in the database and the wavenumber equivalent value of the position specified peak. Thereby, in a case where the position of the measurement peak differs from the removal target wavenumber equivalent value exceeding the allowable error due to a measurement problem or the like even though it is originally to be removed from the measurement spectrum, the allowable error can be corrected, so that a removal target peak that could not be identified due to the problem of error can be automatically identified in the same manner as the position specified peak.

### Aspects

It is obvious to those skilled in the art that the exemplary embodiments described above are specific examples of the following aspects.

(Item 1) A spectrophotometer according to one aspect of the present invention comprises: a measurement spectrum acquisition unit configured to acquire a measurement spectrum indicating a relationship between a wavenumber equivalent value and intensity, obtained by spectrophotometric measurement; a measurement spectrum peak identifying unit configured to identify a measurement peak which is a peak existing in the measurement spectrum; a removal target wavenumber equivalent value acquisition unit configured to acquire, from a database, a removal target wavenumber equivalent value which is a wavenumber equivalent value of a peak attributed to a molecule of a known component whose concentration in a measurement atmosphere fluctuates; and a removal target peak removing unit configured to perform processing of removing, from the measurement spectrum, a measurement peak located at a position corresponding to the removal target wavenumber equivalent value.

(Item 5) A spectrometric data processing method according to one aspect of the present invention includes: a measurement spectrum acquisition step of acquiring a measurement spectrum indicating a relationship between a wavenumber equivalent value and intensity, obtained by spectrophotometric measurement; a measurement spectrum peak identifying step of identifying a measurement peak which is a peak existing in the measurement spectrum; a removal target wavenumber equivalent value acquisition step of acquiring, from a database, a removal target wavenumber equivalent value which is a wavenumber equivalent value of a peak attributed to a molecule of a known component whose concentration in a measurement atmosphere fluctuates; and a removal target peak removing step of performing processing of removing, from the measurement spectrum, a measurement peak located at a position corresponding to the removal target wavenumber equivalent value.

According to the spectrophotometer according to Item 1 and the spectrometric data processing method according to Item 5, a removal target wavenumber equivalent value, which is a wavenumber equivalent value in a removal target peak attributed to a molecule of a known component whose concentration in a measurement atmosphere fluctuates, such as water (water vapor) or carbon dioxide in the atmosphere on a measurement optical path or the like, is acquired from a database, and then a measurement peak located at a position (having a wavenumber equivalent value) corresponding to the removal target wavenumber equivalent value is removed from the measurement spectrum. Therefore, it is possible to prevent a measurement peak whose concentration in the measurement atmosphere does not fluctuate from being erroneously removed as an unnecessary component peak whose concentration fluctuates, thereby making it possible to obtain a correct absorbance spectrum or transmittance spectrum.

(Item 2) In the spectrophotometer according to Item 2, in the spectrophotometer according to Item 1, the removal target wavenumber equivalent value is a wavenumber equivalent value of a peak attributed to water or carbon dioxide.

According to the spectrophotometer according to Item 2, an unnecessary component peak attributed to water (water vapor) or carbon dioxide contained in the atmosphere in the measurement atmosphere is removed, thereby making it possible to obtain a correct absorbance spectrum or transmittance spectrum.

(Item 3) The spectrophotometer according to Item 3, in the spectrophotometer according to Item 1 or 2, further comprises: a display unit; and a display control unit configured to perform control to display the measurement spectrum on the display unit so as to highlight a measurement peak located at a position corresponding to the removal target wavenumber equivalent value.

According to the spectrophotometer according to Item 3, the operator can understand the removal target peaks contained in the measurement spectrum at a glance.

(Item 4) The spectrophotometer according to Item 4, in the spectrophotometer according to any one of Items 1 to 3, further comprises: a display unit; a display control unit configured to perform control to display the measurement spectrum on the display unit; a position specifying processing unit configured to specify a position on the measurement spectrum displayed on the display unit by an input operation of an operator; and a position specified peak detection unit configured to detect a position specified peak which is a peak existing at the position specified by the position specifying processing unit, wherein the removal target peak removing unit is configured to further perform processing of removing the position specified peak from the measurement spectrum.

According to the spectrophotometer according to Item 4, a position specified peak, which was not selected as a removal target peak because the removal target wavenumber equivalent value is not stored in the DB even though it should originally be removed from the measurement spectrum, can be removed from the measurement spectrum.

### REFERENCE SIGNS LIST

10... Spectrophotometer (FTIR)

11... Light source

12... Interferometer

13... Sample holder

14... Detector

15... Data processing unit

151... Measurement spectrum acquisition unit

152... Measurement spectrum peak identifying unit

153... Removal target wavenumber equivalent value acquisition unit

154... Removal target peak removing unit

155... Absorbance spectrum calculation unit

156... Display control unit

157... Peak position input processing unit

158... Position specified peak detection unit

16... Database (DB)

17... Input unit

18... Display unit

80... Sample

1. A spectrophotometer comprising: a measurement spectrum acquisition unit configured to acquire a measurement spectrum indicating a relationship between a wavenumber equivalent value and intensity, obtained by spectrophotometric measurement; a measurement spectrum peak identifying unit configured to identify a measurement peak which is a peak existing in the measurement spectrum; a removal target wavenumber equivalent value acquisition unit configured to acquire, from a database, a removal target wavenumber equivalent value which is a wavenumber equivalent value of a peak attributed to a molecule of a known component whose concentration in a measurement atmosphere fluctuates; and a removal target peak removing unit configured to perform processing of removing, from the measurement spectrum, a measurement peak located at a position corresponding to the removal target wavenumber equivalent value.

2. The spectrophotometer according to claim 1, wherein the removal target wavenumber equivalent value is a wavenumber equivalent value of a peak attributed to water or carbon dioxide.

3. The spectrophotometer according to claim 1, further comprising: a display unit; and a display control unit configured to perform control to display the measurement spectrum on the display unit so as to highlight a measurement peak located at a position corresponding to the removal target wavenumber equivalent value.

4. The spectrophotometer according to claim 1, further comprising: a display unit; a display control unit configured to perform control to display the measurement spectrum on the display unit; a position specifying processing unit configured to specify a position on the measurement spectrum displayed on the display unit by an input operation of an operator; and a position specified peak detection unit configured to detect a position specified peak which is a peak existing at the position specified by the position specifying processing unit, wherein the removal target peak removing unit is configured to further perform processing of removing the position specified peak from the measurement spectrum.
